(19) United States
(12) Patent Application Publication
(10) Pub. No.: US 2011/0072378 A1
(43) Pub. Date: Mar. 24, 2011

(54) METHOD AND APPARATUS FOR VISUALIZING ENERGY CONSUMPTION OF APPLICATIONS AND ACTIONS

(75) Inventors: Jukka Nurminen, Espoo (FI); Heikki Waris, Helsinki (FI)

(73) Assignee: Nokia Corporation, Espoo (FI)

(21) Appl. No.: 12/566,134

(22) Filed: Sep. 24, 2009

(51) Int. Cl. G06F 3/048

(52) U.S. Cl. 715/771; 340/636.1

(57) ABSTRACT

An approach is provided for measuring and visualizing energy consumption of actions or applications. Energy consumption information is determined about an action or an application configured to be executed on a user equipment. Presentation is caused, at least in part, via a graphical user interface of the user equipment, of the energy consumption information along with a visual indicator representing the action or the application.

### BACKGROUND

Service providers (e.g., wireless, cellular, etc.) and device manufacturers are continually challenged to deliver value and convenience to consumers. A myriad of applications from entertainment to business are available to users over an equally wide array of electronic devices, e.g., laptop computers, personal digital assistants (PDAs), portable music players, smart mobile phones, etc. The portability and hence convenience of such devices are dictated by battery life. The various applications can greatly impact battery life differently, as certain applications require different amounts of energy. For example, an application that invokes energy intensive operations within the electronic device (e.g., communicating over the transceiver of a mobile phone to obtain data) is relatively costly in terms of battery life. Hence, usability of the electronic device, particularly when the user depends on mobility, is greater hindered. Traditionally, there has been a lack of detailed energy consumption information to users of the devices, thus users have been unable to make energy informed decisions. In particular, only a general estimate of a usage time of the entire device has been provided—i.e., the number of minutes remaining on the battery. For example, an electronic device may display an estimated remaining usage time or a battery power bar to convey the power status of the electronic device.

### SOME EXAMPLE EMBODIMENTS

According to one embodiment, a method comprises determining energy consumption information of an action or application configured to be executed on a user equipment. The method also comprises causing, at least in part, presentation, via a graphical user interface of the user equipment, of the energy consumption information along with a visual indicator representing the action or the application.

According to another embodiment, an apparatus comprising at least one processor, and at least one memory including computer program code, the at least one memory and the computer program code configured to, with the at least one processor, cause the apparatus to determine energy consumption information of an action or application configured to be executed on a user equipment. The apparatus is also caused to cause, at least in part, presentation, via a graphical user interface of the user equipment, of the energy consumption information along with a visual indicator representing the action or the application.

According to another embodiment, a computer-readable storage medium carrying one or more sequences of one or more instructions which, when executed by one or more processors, cause an apparatus to determine energy consumption information of an action or application configured to be executed on a user equipment. The apparatus is also caused to cause, at least in part, presentation, via a graphical user interface of the user equipment, of the energy consumption information along with a visual indicator representing the action or the application.

According to another embodiment, an apparatus comprises means for determining energy consumption information of an action or application configured to be executed on a user equipment. The apparatus also comprises means for causing, at least in part, presentation, via a graphical user interface of the user equipment, of the energy consumption information along with a visual indicator representing the action or the application.

According to one embodiment, a method comprises determining energy consumption information for a plurality of applications configured to be executed on a user equipment. The method also comprises causing, at least in part, to associate the energy consumption information with the respective applications as part of an online service.

According to another embodiment, an apparatus comprising at least one processor, and at least one memory including computer program code, the at least one memory and the computer program code configured to, with the at least one processor, cause the apparatus to determine energy consumption information for a plurality of applications configured to be executed on a user equipment. The apparatus is also caused to cause, at least in part, to associate the energy consumption information with the respective applications as part of an online service.

According to another embodiment, a computer-readable storage medium carrying one or more sequences of one or more instructions which, when executed by one or more processors, cause an apparatus to determine energy consumption information for a plurality of applications configured to be executed on a user equipment. The apparatus is also caused to cause, at least in part, to associate the energy consumption information with the respective applications as part of an online service.

According to another embodiment, an apparatus comprises means for determining energy consumption information for a plurality of applications configured to be executed on a user equipment. The apparatus also comprises means for causing, at least in part, to associate the energy consumption information with the respective applications as part of an online service.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of measuring and visualizing energy consumption of applications and actions, according to one embodiment;

FIG. 2 is a diagram of the components of energy consumption module, according to one embodiment;

FIGS. 3 and 4 are flowcharts of processes for determining and presenting energy consumption information of actions and/or applications, according to various embodiments;

FIG. 5 is a flowchart of a process for determining and presenting energy consumption information of filtered and unfiltered actions, according to one embodiment;

FIGS. 6A through 6D are diagrams of user interfaces utilized in the processes of FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

A method and apparatus for measuring and visualizing energy consumption of applications and actions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

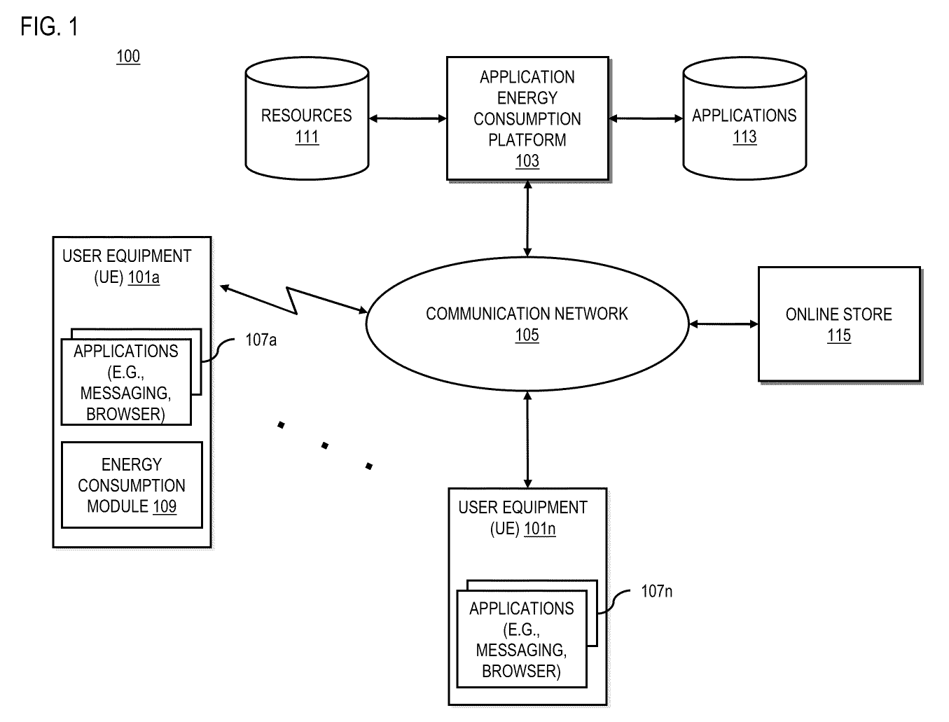

FIG. 1 is a diagram of a system capable 100 of determining, associating, and presenting energy consumption of actions and/or applications to users, according to one embodiment. As mentioned, users of electronic devices are unaware of the energy or power that is consumed for the various applications and actions supported by these devices. Moreover, each action or application that can be executed on these devices require different amount of energy. Traditional mechanisms to present energy information of the electronic devices to users are inadequate, in that they do not convey any energy information about the applications that reside on the devices or that the users may download to the respective devices of the users. Given the variety of applications that a user may select to utilize, it may be the case that if a user has knowledge of the high energy consumption of a particular application, the user may not elect to launch such application if battery life is of a concern.

Accordingly, the system 100 of FIG. 1 introduces the capability to determine, associate, and present the energy or power consumption of applications and/or actions to users. With more detailed energy information, users can intelligently manage the operation of their devices with respect to the applications. In this manner, the user can conserve energy (and thus extend battery life) by inactivating applications that consume more energy at the appropriate times. In addition to applications, it is contemplated that energy management can be performed with respect to “actions” executed by the electronic devices, in general. In accordance with certain embodiments, energy information may include any data or parameters relating to the consumption or expenditure of electricity. According to certain embodiments, the term “action” refers to an event, function, capability, or other activities that consume power and that can be caused to occur on a UE 101. Examples of an action include executing a web link, initiating a phone call, initiating a voice session over an internet connection, and sending a message.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

In one embodiment, user equipment (UE) 101, such as mobile devices, may be used to collect energy consumption information of the applications and/or actions. In certain embodiments, “energy consumption information” includes measurements of the action or application 107, determinations of energy consumption (e.g., a determined energy consumption rating, an energy consumption rate, energy consumption timing information, etc.) and/or other like energy use related information. Once the energy consumption information is collected, the energy consumption information can be processed or transmitted to an application energy consumption platform 103 via a communication network 105. The UE 101 can detect the energy consumption of actions and/or applications 107 (e.g., a messaging application, a web browser, etc.) via an energy consumption module 109. This capability can advantageously permit the user to evaluate which application and/or actions are more critical to invoke, particularly in situations where battery power may be low. For instance, assuming the UE 101 is a mobile phone, if the battery power is low, the user can effectively “reserve” the energy for the phone functions, rather than execute a gaming application, or a browser application to “surf” the web.

As seen in FIG. 1, the application energy consumption platform 103 can include a resources database 111 and an associated applications database 113 to store energy consumption data as well as other resource usage data collected from one or more energy consumption modules 109. The application energy consumption platform 103 can then send an online store 115, via the communication network 105, resource information (e.g., energy consumption data, memory consumption information, processor consumption information, etc.) associated with applications 113. The online store 115 can present the resource information with its respective application to users wishing to purchase applications.

In one embodiment, application 107 and action energy consumption information is collected by the energy consumption module 109. The energy consumption module 109 may also detect and store data about what applications 107 and/or actions are active on the UE 101 when the energy consumption information is collected. Data about the energy consumption of the UE 101 can include energy usage of the UE 101, the energy usage of one or more components of the UE 101, or the like. A power meter can be connected to various parts of the UE 101 to determine the rate of energy being used by the UE 101 or its components. The power meter(s) can detect the current flowing from a power source and a voltage drop of the power source to determine power consumption and/or a power consumption rate.

In another embodiment, an energy consumption module 109 associated with an application energy consumption platform 103 can determine the energy consumption of an application 107 or action on a UE 101. The energy consumption module 109 can be a part of the UE 101 or external to the UE 101 as part of an application energy consumption platform 103. Moreover, more than one energy consumption module 109 on one or more UEs 101 or energy consumption platforms 103 may be used in combination to determine energy consumption information. Additionally, the energy consumption information collected by the energy consumption module 109 can be stored in a resources database 111 that associates each action or application 107 with resources consumed, including power, during the execution of the application 107 or action. Other resources can include memory, processor utilization, network interface utilization, etc. The energy consumption information can additionally be associated with a particular type of UE 101. This information can be used to set a default energy consumption rating associated with the particular type of UE 101. Thus, collected energy consumption data of an application 107 or action can be specific to the type of UE 101. Further, the collected energy consumption data may be specific to an application 107; and a formula may be used to estimate the energy consumption of the application 107 on another type of UE 101. One method of calculating this energy consumption information is to determine a relative energy consumption rating of the type of UE 101 and the other type of UE 101 and use this rating as a scale. Energy consumption information of the application 107 executing on the other type of UE 101 can then be scaled to estimate the energy consumption of the application 107 on the type of UE 101. The collected energy consumption data of the application or action may also be specific to a user. This can be determined based on objective data collected about the manner (e.g., performance settings) that the user utilizes the user's UE 101.

Additionally, the energy consumption module 109 can collect data representing parameters, such as configuration settings, of the application 107 or action. In some instances, the parameters of the application 107 or action can greatly change the energy consumption of a UE 101. In one example, a setting of an email application 107 relating to updating frequency can be associated with a time parameters (e.g., check for an update every minute, every 10 minutes, every hour, etc.) defining the frequency that the UE 101 checks for email updates. The more frequent the update checks, the more the application 107 uses the UE 101 components, and the more energy is consumed.

Power consumption of each update can be determined or an average power consumption over a time period can be determined for the application 107 in general or specifically for the use of the application 107 on a type of UE 101. Additionally, raw energy consumption information can be processed at a testing and/or development facility that can utilize the UE 101 and/or external hardware to determine processed energy consumption information of the application 107 using various parameters (e.g., timing parameters). This processed energy consumption information can be stored in the resources database 111 and/or delivered to UEs 101.

Additionally, energy consumption information can be delivered to an online store 115. The online store 115 can sell or otherwise provide applications 107, video, audio, and other content to UEs 101. As such, the online store 115 can present the delivered energy consumption information about an application 107 with the application 107 when providing the application 107 to a user. In certain examples, the online store 115 can sort the presented applications 107 or other files that can be used by actions to users sorted based on energy consumption. For example, video content at the online store 115 can be offered to a user with various alternative formats. The formats can have energy consumption information (e.g., an energy rating system) associated with each video file (e.g., certain formats may need more extensive decoding). The online store 115 can present the energy rating to the user when offering the content. For example, the content can be associated with an icon and the icon can be tinted or shaded a color based on the energy rating (e.g., green for low energy use, red for great energy use) of the content. Alternatively, instead of colors, other indicia can be utilized, such as stylized text or an alteration to the icon, such as adding certain effects (e.g., smoke or flames) to an icon that uses more energy. Further, the indicator could be an overlay icon, such as a thermometer with different levels of energy use or an energy bar.

In yet another embodiment, a UE 101 can receive the energy consumption information from the application energy consumption platform 103 for an application 107. Then, the UE 101 can collect additional energy consumption information about the application 107 using an energy consumption module 109 of the UE 101. The UE 101 can then process the collected energy consumption information, using the energy consumption information from the application energy consumption platform 103 as a baseline starting point. Then, the UE 101 can determine energy consumption information about the application 107 particular to the UE 101. The determined energy consumption information can then be used to determine useful information, such as a battery life of the UE 101 if the application 107 was activated from an inactive state or the battery life of the UE 101 if an active application 107 was deactivated. Additionally, advisory information, such as advice on how to increase battery life, can be determined and displayed to a user of the UE 101.

In one embodiment, UEs 101 can send collected energy consumption information about an application 107 to the application energy consumption platform 103. The energy consumption information about the application 107 can be stored in the resources database 111. The energy consumption information can be stored as specific as to the use of the application 107 on a certain type of UE 101 or a general use of the application 107. Additionally, the energy consumption information can be raw data (e.g., data points representing the power usage of the UE 101 while the application 107 is executing) or processed data (e.g., average power consumption of the application 107 on the UE 101).

The energy consumption information from the UEs 101 can be used to determine community averages from a plurality of users of the application 107 on UEs 101. A community based average can be useful in determining the energy consumption rate of the application 107 on the UEs 101. The community average energy consumption rate of the application 107 can then be transmitted to a UE 101. This UE 101 can utilize the community average energy consumption rate to determine useful energy related information (e.g., how long the UE 101 can operate if the application 107 is activated) about the application 107. Additionally, the community averages and stored energy consumption information can be useful for research and development of new applications 107 and new UEs 101.

As shown in FIG. 1, the system 100 comprises a user equipment (UE) 101 having connectivity to a application energy consumption platform 103 and an online store 115 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101, application energy consumption platform 103, and online store 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Although various embodiments are described with respect to applications, it is contemplated that the approach described herein may be used generally with actions or functions that consume energy. As such, energy consumption information associated with these actions can be measured and processed using the same or similar approaches.

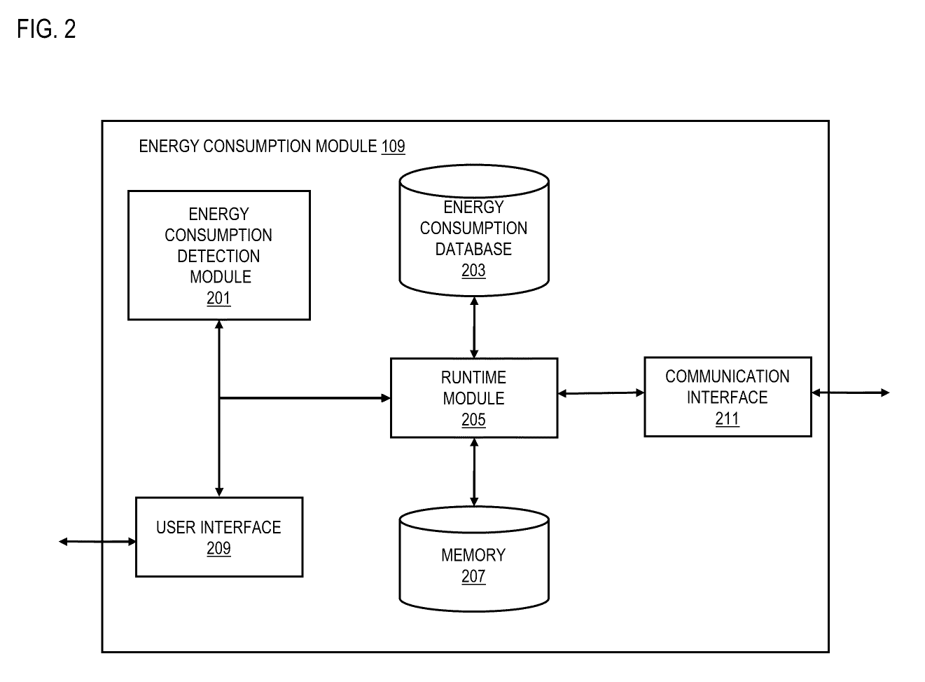

FIG. 2 is a diagram of the components of an energy consumption module 109, according to one embodiment. By way of example, the energy consumption module 109 includes one or more components for measuring and conveying energy consumption to a user. It is contemplated that the functions of these components may be combined in one or more components or performed by other components of equivalent functionality. In this embodiment, the energy consumption module 109 includes an energy consumption detection module 201, an energy consumption database 203, a runtime module 205, a memory 207, a user interface 209, and a communication interface 211.

In one embodiment, the energy consumption module 109 includes an energy consumption detection module 201. The energy consumption detection module 201 may be used by a runtime module 205 to retrieve energy consumption information from a UE 101 and store the energy consumption information in an energy consumption database 203. In certain embodiments, energy consumption information includes a measurement of energy consumption (e.g., an energy consumption rate, total energy consumption over a period of time, total energy consumption, etc.) of the UE 101 or components of the UE 101, the active applications and/or actions executing on the UE 101 at the time(s) of data collection, and/or the collection of other energy related information. The energy consumption rate can be determined by the amount of energy consumed over a period of time. Additionally, the energy consumption detection module 201 can utilize power metering electronics to determine the energy consumption rate of particular components of the UE 101 and store that information in an energy consumption database 203. In some scenarios, the power metering electronics can be a part of the UE 101, in other scenarios; the power metering may be external to the UE 101.

In one embodiment, the energy consumption module 109 includes a communication module 211. The runtime module 205 can send and receive the energy consumption information and other energy related information via the communication interface 211 and store the energy consumption information in the energy consumption database 203. An energy consumption module 109 associated with the application energy consumption platform 103 can receive energy consumption information from a plurality of UEs 101. The UEs 101 can send the data via a communication interface 211 of an associated energy consumption module 109.

In one embodiment, an energy consumption module 109 includes a user interface 209. The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, a microphone, etc. The user interface 209 can be used to display energy information to a user.

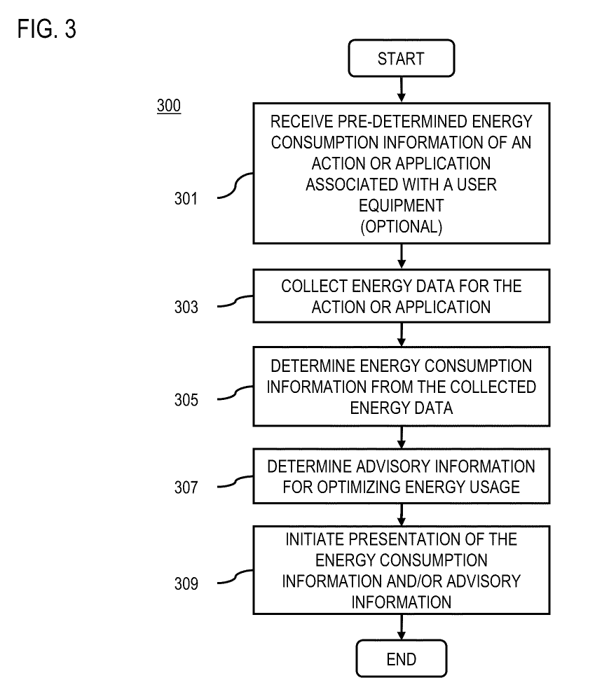

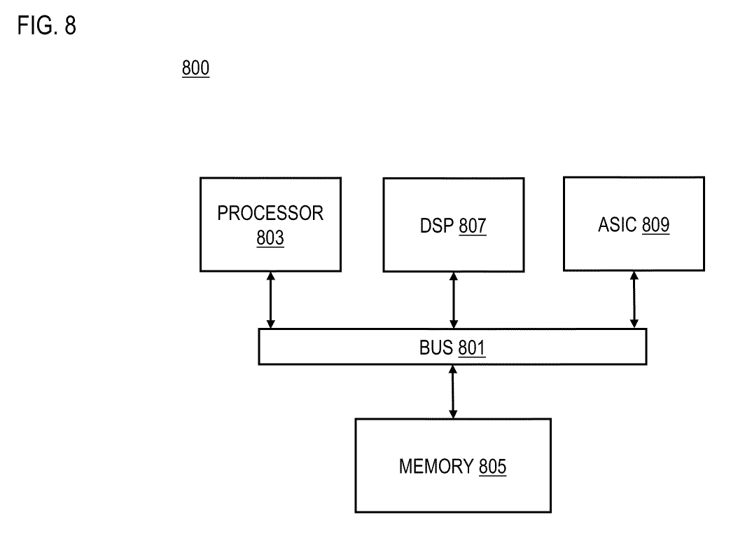

FIG. 3 is a flowchart of a process for determining and presenting energy consumption information of actions and/or applications 107, according to one embodiment. In one embodiment, the runtime module 205 performs the process 300 and is implemented in, for instance, a chip set including a processor and a memory as shown FIG. 8. When deciding to execute an application 107 on a UE 101, the user of the UE 101 may wish to see energy consumption information about the UE 101 if the UE 101 executes the application 107. This energy consumption information can include information that is or can lead to the determination of advisory information that can be useful to a user (e.g., a battery life if the application 107 was activated, a battery life if an action or application 107 was deactivated, a comparison rating of the energy consumption of multiple actions or applications 107, etc.). An energy consumption module 109 located on the UE 101 or other device can be used to collect the energy consumption information.

In step 301, the runtime module 205 of the energy consumption module 109 receives pre-determined energy consumption information of an application 107 associated with a UE 101. This energy consumption information can be determined by an application energy consumption platform 103, another UE 101, or any device with an energy consumption module 109. An application energy consumption platform 103 can determine the pre-determined energy consumption information by collecting energy consumption information from one or more energy consumption modules 109 associated with devices running the application 107. The collected energy consumption information could include one or more baseline measurements of the UE 101 without any applications or actions executing or with baseline applications or actions executing. Additionally, the energy consumption information can include measurements of the UE 101 with the baseline applications and/or actions executing as well as the application 107 or action in question. The application energy consumption platform 103 can compare the baseline measurements to the measurements including the application 107 in question to determine an energy consumption average, which can be one form of energy consumption information. The energy consumption information can also include energy consumption based on settings of an application 107. For example, an application 107 may consume less power if the application 107 updates less frequently.

Then, at step 303, the runtime module 205 collects energy consumption information about the application 107 via an energy consumption detection module 201. Under one scenario, the collected energy consumption information includes the energy consumption of the UE 101 and information about the applications 107 and/or actions executing on the UE 101 when the collected energy consumption information is being collected. The collected energy consumption information can be collected using one or more power meters that determine the power used by the UE 101 as a whole or components of the UE 101 (e.g., a network module, a processor, a memory, etc.). Additionally, resource consumption information from the components may be collected. In one scenario, the collected energy consumption information can include, for example, the power consumption of the component (e.g., the network module) as well as the utilization information of the component by each active application 107 and/or action. With this information, a more accurate estimate as to how much energy a particular application 107 consumes can be ascertained. Energy consumption information can be stored in an energy consumption database 203 as a baseline for determining energy consumption information.

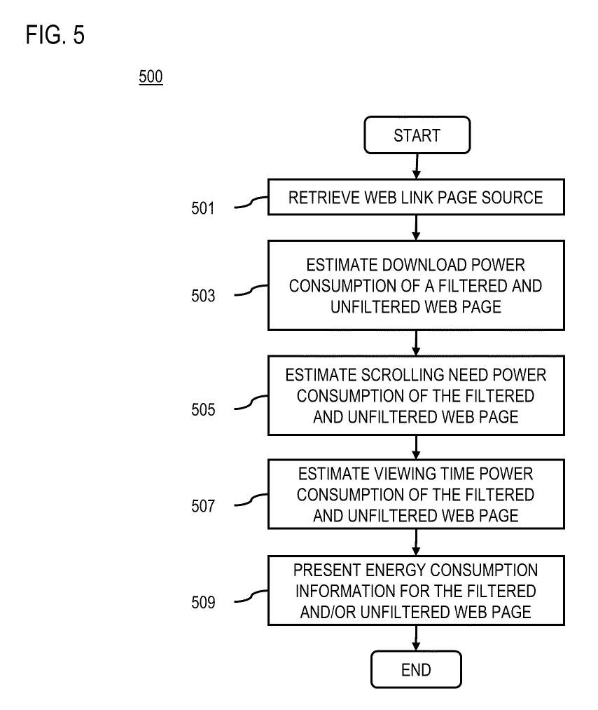

In one embodiment, at step 305, the runtime module 205 determines energy consumption information from the collected energy consumption information. The baseline information can be formulated to include various applications 107 and/or actions that can be executed by a UE 101. In one example, the baseline information can be based on the pre-determined energy consumption information. In another example, the baseline information is based on the collected energy consumption information. Alternatively or additionally, the baseline information can be based on both the pre-determined energy consumption information and the collected energy consumption information. In this way, different energy consumption information can be used for different scenarios. For example, a user of a UE 101 is interested in activating Application A on the UE 101 and would be interested in ascertaining the power consumption of Application A. The UE 101 is running Applications X, and Y as well as Action Z. The UE 101 can search the energy consumption information for baselines associated with this particular scenario. A first baseline can be associated with the UE 101 running Applications X and Y and Action Z. A second baseline can be associated with the UE 101 running Applications A, X, and Y as well as Action Z. The baselines can be compared to determine the energy consumption information of Application A. In one example, the energy consumption information can be an estimate based on an assumption that Applications X and Y and Action Z consume a constant average power rate based on the first baseline information. In another example, the energy consumption information can be an estimate based on Applications X, and Y as well as Action Z following the first baseline. Additionally, the baselines can correspond to the energy consumption of specific components of a UE 101 (e.g., energy consumption of a network module while the application 107 is active or the energy of a display). In some embodiments, the energy consumption information can be determined based on components of the UE 101 as exemplified in FIG. 5. In other embodiments, the consumption of other resources (e.g., memory use, network use, etc.) may be gathered and analyzed in a similar manner to the energy consumption information.

Then, at step 307, the runtime module 205 determines advisory information for optimizing energy usage. The advisory information can include, for example, instructions on how to increase a battery life of the UE 101. Alternatively, other resource consumption (e.g., memory use, network use, etc.) of the application 107 can be used to determine the advisory information. In one scenario, an application 107 and/or action can have options that affect the energy consumption of the UE 101. For example, in an e-mail application 107, standby energy consumption of the application 107 is affected by the frequency of checking for updates. The energy consumption information can include baselines based on some or all of the options utilized by an application 107 and/or an action. The runtime module 205 can parse the information in the energy consumption information to determine alternative settings that can be displayed to the user of a UE 101 that have different power consumption attributes. Then a user is able to select from various energy consumption options. These options can be displayed to the user in the form of a sliding interface where the user is able to select, in a sliding fashion, the energy consumption rate or productivity of the application 107. With this approach, the user is able to change many underlying parameters using an interface that facilitates the activity by allowing the user to select an end result. Moreover, the user may set an option to allow a background service of the UE 101 optimize application use without subsequent user intervention. The service can have access to the energy consumption information of the applications 107 available on the UE 101 and can determine change the underlying parameters dynamically based on UE 101 context, such as battery life remaining.

Then, at step 309, the runtime module 205 initiates presentation of the energy consumption information and/or advisory information. The presentation of the energy consumption information can take place using an energy user interface mode or a user interface theme that includes the presentation of energy consumption information. In certain embodiments, the energy user interface mode can be automatically invoked if the battery energy of an associated battery goes below a threshold power value. In certain scenarios, the energy consumption information can be formatted to provide relevant information to the user. For example, the energy consumption information can be formatted to display information about the amount of time the application 107 can be used if the application 107 is activated. In another embodiment, the energy consumption information can be formatted to communicate the information via an auditory output of the user equipment or via, for example, a haptic output of the user equipment. An exemplary auditory or haptic output use can be a sound or vibration if it is detected that an application 107 is using more than a certain threshold energy consumption rate. The time information can be determined using an average energy consumption rate from the energy information and an energy capacity level of a battery of the UE 101. The energy capacity of the battery can be determined by electronic circuitry (e.g., based on the voltage level of the battery). The energy consumption rate of active applications 107 can also be computed based on predetermined baseline energy consumption information for these applications 107. The average energy consumption rate of the application 107 and currently executing applications 107 and/or actions can be used to determine the execution time. Additionally, the time information can be computed as follows:

Remaining battery time=total remaining battery energy/average energy consumption rate.

Once the energy consumption information is formatted, the energy consumption information can be presented to the user via a graphical user interface. The energy consumption information can be presented in conjunction with a visual indicator (e.g., an icon, a web link, etc.) representing the application 107.

Under one scenario, a user may be using a UE 101 with low total remaining battery energy, whereby the user seeks to perform the action of contacting another person. By way of example, to initiate this process, the user invokes a contact list or lists, which reveals that the other party can be reached in different ways. That is, the UE 101 supports communicating with the other party via several methods, e.g., a cellular channel, a Voice over Internet Protocol (VoIP) channel, messaging channel (e.g., short messaging service (SMS) or multimedia messaging service (MMS)), etc. The UE 101 provides a user interface that displays an energy or power rating (and/or an estimated talk time) for each of the contacts using the different communication approaches. In this context, the user can be presented energy consumption information that informs the user that significantly more talk time is available over the voice over internet protocol channel than via a cellular channel (e.g., because a cellular channel consumes more energy than a voice over internet protocol channel). The user can then select which person to call and/or the manner to call the person based on the presented energy consumption information. In another scenario, the user may select a game application among multiple applications 107 on the UE 101 depending on what amount of battery life would remain after use of the game application 107 in comparison to other applications 107.

Utilizing the above approach, a user is able to make energy conscious decisions on which applications 107 or actions to utilize. In this manner, the user is provided energy information that allows the user to understand how the user can affect the energy consumption of a UE 101 by the manner the user uses the UE 101. Thus, the battery life of a UE 101 can be improved by providing feedback of the energy consumption of applications 107 or actions to the user.

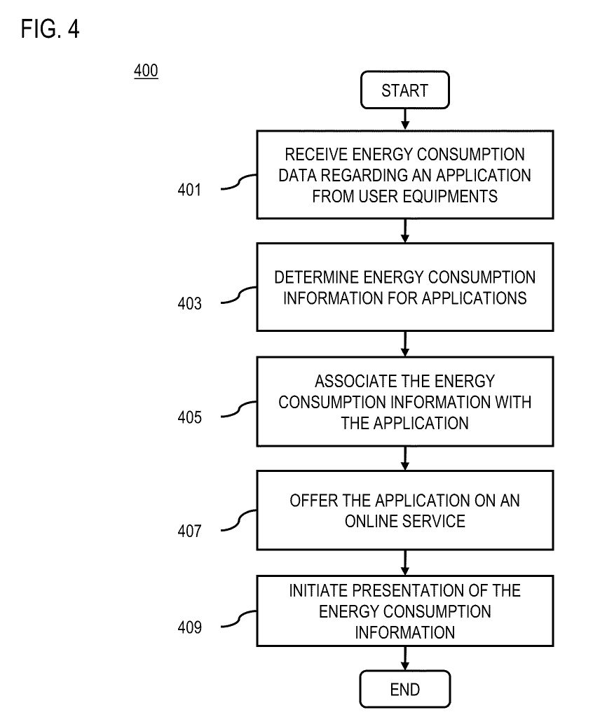

FIG. 4 is a flowchart of a process for determining and presenting energy consumption information of applications, according to one embodiment. Under this scenario, an online service such as an online store 115 is configured to provide energy consumption information as part of the information that is supplied to users during purchase of applications (for download). In one embodiment, the runtime module 205 performs the process 400 and is implemented in, for instance, a chip set including a processor and a memory as shown FIG. 8. When selecting an application 107 to download from the online store 115, a user of the UE 101 may wish to ascertain information relating to the effect that the application 107 will have on the energy consumption (e.g., battery life) of the UE 101. Energy consumption information can be determined for the application 107 based on information from various UEs 101 within system 100 or via measurement and testing conducted by the application energy consumption platform 103.

At step 401, the runtime module 205 receives energy consumption information regarding the application 107 from one or more user equipments 101 via energy consumption modules 109. The energy consumption information can include baseline values of the energy consumption of the application 107 on one or more types of UEs 101. For example, the energy consumption information can be specific to the type (e.g., a model of a mobile terminal) of UE 101 of the UE 101.

Then, at step 403, the runtime module 205 can determine energy consumption information for the application 107 or a plurality of applications 107 configured to be executed on the UE 101. The energy consumption information can be determined based on the received energy consumption information (e.g., based on baselines as discussed in the processes of FIG. 3). The received energy consumption information can be used as the basis for determining community average energy consumption baselines and information for the application 107. According to certain embodiments, communities can be grouped according to hierarchies. As such, the one community can include all users or all registered users of the application energy consumption platform 103. Other communities can be individualized to a user. For example, a community could be based on common attributes about users in the community such as country of residence, age, used applications, etc. Community average energy consumption information can be determined by averaging or performing a statistical analysis on data from multiple sources. In one example, the energy consumption information is based on a UE 101 type. The energy consumption information can be accumulated from UEs 101 reporting energy consumption information from each UE 101. The runtime module 205 can then determine baselines for the application 107 alone and in conjunction with other applications 107. Once baselines are determined for an application 107, the runtime module 205 can determine the energy consumption information for that application 107. For example, the energy consumption information can include the amount of time a particular type of UE 101 can run the application 107 on a fully charged battery. In another example, the energy consumption information can include the amount of time the UE 101 can run the application 107 on a fully charged battery if certain other applications 107 and/or actions were also being executed. Additionally, the energy consumption information can include a rating of the energy consumption rate of the application 107.

Next, at step 405, the runtime module 205 can associate the energy consumption information with the application 107. Once the baselines are determined, the energy consumption information (e.g., an energy rate or an energy consumption rating) can be associated with the application 107. The energy consumption information can be associated with the application 107 by storing the associated information in a memory or a database.

At step 407, the application 107 can be offered via the online store 115 for free, for a price, via subscription, etc. UEs 101 can download or order applications from the online store 115. At step 409, the online store 115 can initiate presentation of the energy consumption information in conjunction with the application 107. The energy consumption information can be appropriately formatted for presentation via UE 101 to the user. In one embodiment, the presentation can include ratings for each of the applications 107 based on the energy consumption information. In one example, an icon or other visual indicator representing the application 107 can be color coded, with predetermined colors based on the ratings. In another example, the online store 115 can sort the presentation of multiple applications based on the energy efficiency of the applications 107. Thus, a user is provided the opportunity to select an application 107 based on the energy efficiency of the application 107. For example, a list of applications 107 that perform similar functions can be presented to a user with the associated power rating. This can encourage application makers to develop more efficient applications 107 because users may choose more efficient applications 107 to save on battery life or energy costs. Moreover, the offering of energy efficient applications 107 can be tied to the price of the application or the profit margin split between the online store 115 and the developers. For example, to encourage more efficient applications 107, the online store 115 can offer additional compensation to developers who meet certain energy consumption requirements.

With the above approach, a user is provided application 107 and action level power feedback. Providing this feedback to a user can allow the user to choose which application 107 to download and utilize from an online store 115 based on the required energy consumption of the UE 101. This can also spur the creation of more energy efficient applications 107 because application developers may need to compete with other application developers to provide more efficient applications 107 that appeal to users.

FIG. 5 is a flowchart of a process for determining and presenting energy consumption information of filtered and unfiltered actions, according to one embodiment. In one embodiment, the runtime module 205 performs the process 500 and is implemented in, for instance, a chip set including a processor and a memory as shown FIG. 8. It can be beneficial to provide energy consumption information and choices to a user based on an action the user may want to complete on the UE 101. Such actions could involve the display rich content such as JAVASCRIPT, flash, animated images, etc. that use a substantial amount of resources of a UE 101. The use of these resources in turn leads to a greater rate of energy consumption. In certain scenarios, the user would rather use fewer resources and receive less rich content. The user can be provided a filtered and unfiltered web page option to select from based on energy consumption. In one embodiment, the action involves the execution of a web link page. When the user of the UE 101 wishes to view energy consumption information regarding a particular web link, the user can activate an option to view the energy consumption information (e.g., by hovering over a visual indicator associated with the web link).

At step 501, the activation causes the runtime module 205 to retrieve a web link page source from an associated web server. The runtime module 205 then determines filtered and unfiltered energy consumption costs based on the resources needed to fetch, render, and view the web link. Filters used can be based on one or more scripts that can be executed by a web browser. The scripts can be used to block images, animated images, flash, JAVASCRIPT, advertisements, etc. from being downloaded and/or rendered by the UE 101. Scripts can be downloaded from a website to a UE 101 and then can be stored on a memory of the UE 101. Additionally, the scripts can include or can be modified to include user parameters (e.g., preferred font sizes, preferred image sizes, etc.) and/or be customized for a particular type of UE 101. The runtime module 205 can determine an estimate of power consumption of the UE 101 if the web link is activated based on estimated power consumption of components of the UE 101 that the web link may utilize.

At step 503, the runtime module 205 can estimate the power consumption used to download a filtered and/or an unfiltered web page. This power consumption can be estimated based on the amount of data that needs to be transferred for the filtered or unfiltered web page, an average download speed, and an average power consumption rate of a network or communication interface of the UE 101 that is being used to download the web page content. A total amount of data can be calculated from the page source of the web link and/or filtering information as to which portions of the web link to download. The power consumption rate of the network interface can be determined by a power meter associated with the network interface. Additionally, the runtime module 205 can store power meter readings in a memory 207 and use the stored information to determine the average (e.g., a mean, median, etc.) network interface power consumption rate. An average download speed can be calculated based on recent network activity by storing download rates for recent network activity in a memory 207 and using that information to determine an average download rate. The total amount of data divided by the average download speed provides an estimated download time. The estimated download time times the average power consumption rate provides an estimated energy usage. This estimated download energy usage can be used to determine other energy consumption information such as how much battery life the action of activating the web link will consume.

Next, at step 505, the runtime module 205 can estimate the power consumption of displaying and scrolling need to view a filtered and/or an unfiltered web page. The power consumption may be estimated by calculating a ratio of the dimensions of the navigable area (e.g., based on pixels) when the page is rendered in the web browser to the available screen viewing space of the UE 101 (e.g., based on pixels) and determining power consumption information of the components used to display the web page (e.g., a processor, a graphical processor, a display). The navigable area can be determined based on the filtered or unfiltered web page source information in conjunction with information about which content (e.g., images, flash, etc.) is to be downloaded and rendered based on any applicable filtering scripts and in conjunction with user preferences or setting parameters (e.g., font size). This ratio provides the amount of full screens that may be needed to view the entire contents of the web page. A penalty factor (e.g., 1.5) can be multiplied to the ratio to provide for the undesirability of certain attributes (e.g., the need for multi-dimensional scrolling). This weighted ratio can be used to determine an estimated scrolling time of the web page by multiplying a predetermined time constant (e.g., 3 s to scroll to a new section) to the ratio. The scrolling time can be multiplied by the average power consumption of the components used to display the web page to determine scrolling power consumption information. Each component (e.g., display, processor, graphical processor, etc.) can have an individual power meter that can be used to provide power information that can be stored in memory 207 and be used to provide an average power consumption rate of the component.

Then, at step 507, the runtime module 205 can estimate a viewing time power consumption of the filtered and/or unfiltered web page. An estimated viewing time can be calculated by adding a user reading time, a user image and graphics viewing time. A total number of viewable words can be determined from the page source. This number of viewable words can be divided by a user reading speed rate (e.g., words read per second), which can be a predetermined constant value that can be set by the user, to determine a reading time. The duration of any video or animated images can be added to a predetermined time constant multiplier (e.g., in seconds) times a number of viewable images to determine an image and graphics viewing time. The reading time and user image and graphics viewing time can be multiplied with the average power consumption rate of components used to display the content to determine estimated viewing time power consumption. Estimated energy consumption information can be determined by adding the power consumption of the estimated download power consumption, the estimated scrolling power consumption, and estimated viewing time power consumption.

Next, at step 509, the runtime module 205 may present the energy consumption information for the filtered and/or unfiltered web page. This estimated energy consumption information can be used to determine advisory information and other information about the filtered and unfiltered web pages. The presented information can include presentation of the remaining battery life if the link was clicked in either the filtered or unfiltered mode. Additionally or alternatively, the link can be color coded to indicate the magnitude of power consumption of the link. In one example, if a video file is to be displayed on the web link, the link can be color coded red to indicate a greater level of power consumption. In another example, a text file can be colored green to represent a low level of power consumption.

Additionally, when a filtering script is activated on a UE 101, the runtime module 205 can determine how long the page was actually viewed, the amount of scrolling involved, and the download time. This data can be used to improve the accuracy of the power consumption estimates. In this example, multipliers related to the energy estimates can be dynamic based on the gathered historical information instead of a predetermined or a user parameter. For example, the average download time can be modified to include the historical information in the average. This information can also be communicated to a application energy consumption platform 103 to allow the application energy consumption platform 103 to gather more data about the UE 101 and the action.

Under the above approach, a user is provided energy consumption information of actions (e.g., clicking on a web link) the user may wish to perform. Additionally or alternatively, the user is provided information of the energy consumption of a filtered or unfiltered version of a web link. According to the above approach, battery life of the user's UE 101 can be improved by allowing the user to select a power optimized filter to view the web link.

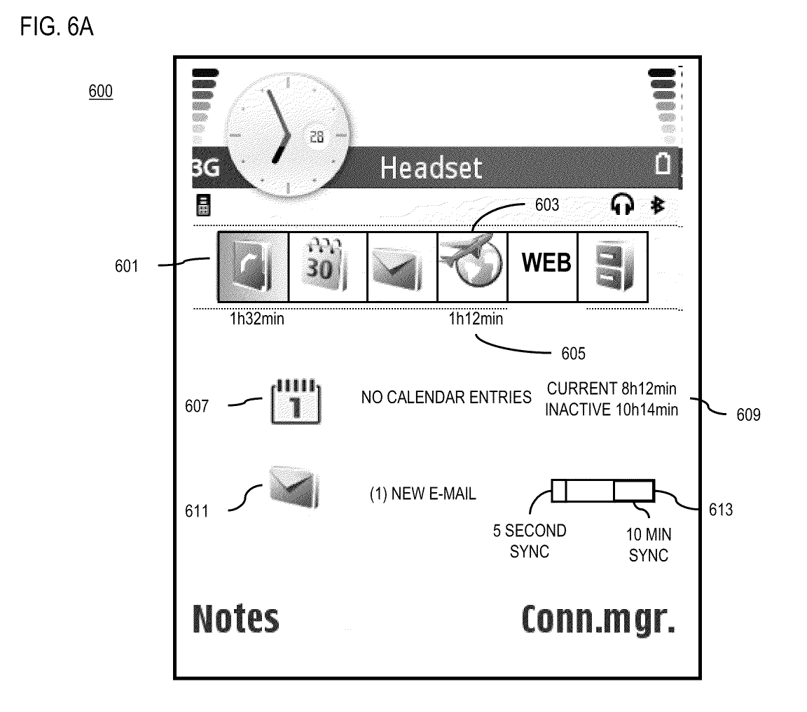

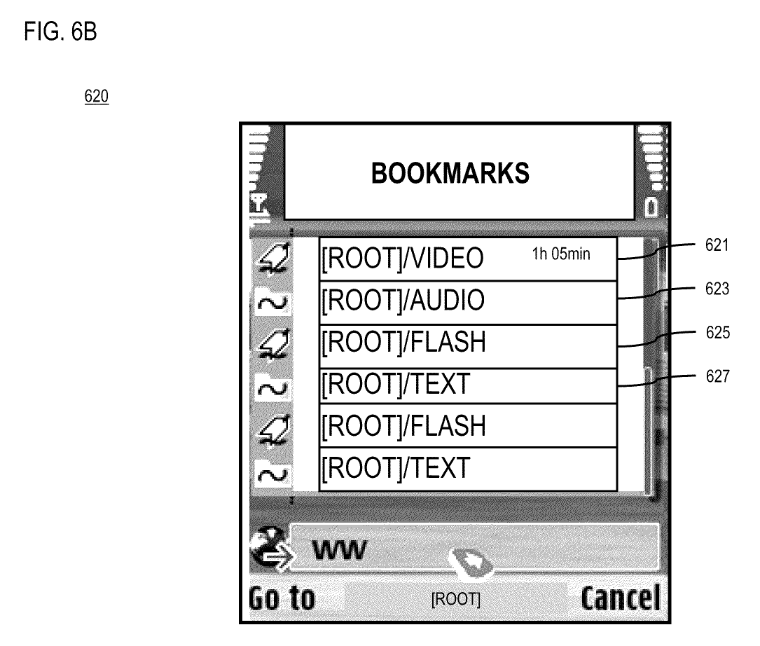

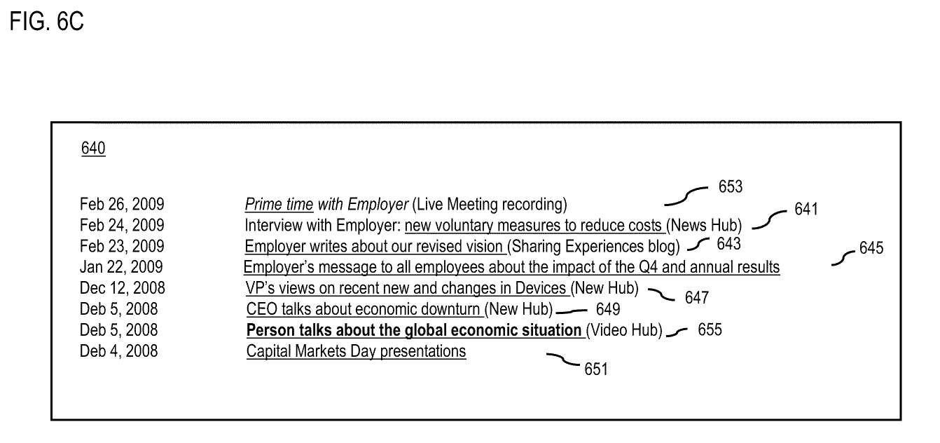

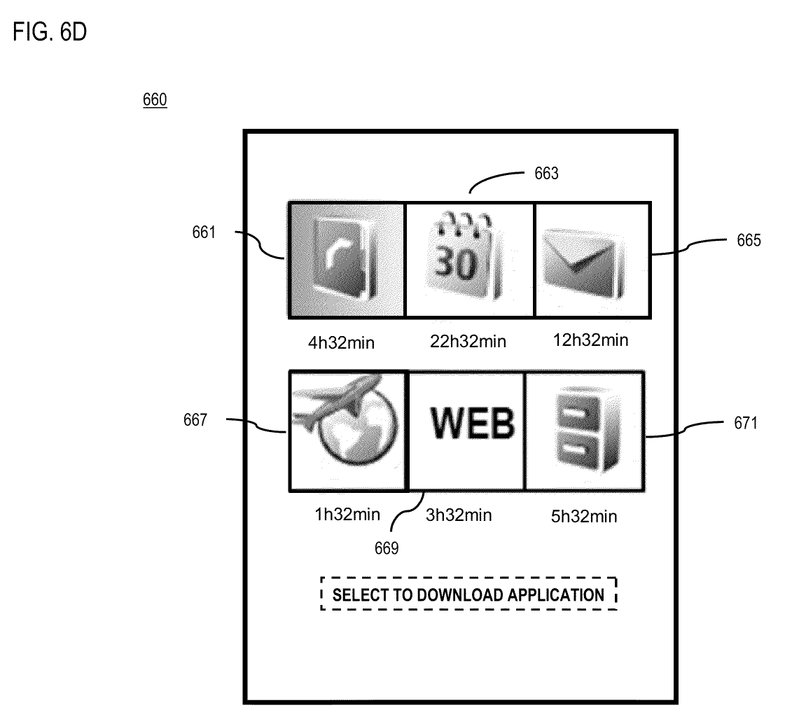

FIG. 6A is a diagram of a user interface 600 utilized in the processes of FIG. 3, according to one embodiment. User interface 600 displays a home screen for a UE 101 that allows for the presentation of energy consumption information to a user. The user interface 600 displays a recently or commonly used actions and/or applications bar 601 that provides visual indicators (e.g., icons) of recently or commonly used programs. Icon 603 represents a positioning and mapping application. An energy consumption module 109 associated with the UE 101 can calculate the remaining battery life if the positioning and mapping application 107 was activated. As shown, the estimated battery life would be 1 hour and 12 minutes if this application 107 was activated. The user interface 600 also includes information about active applications 107 and actions, such as a calendar application 607. The user interface 600 shows a current battery life estimate 609 of 8 hours and 12 minutes with the calendar application 607 running and a battery life estimate 609 of 10 hours and 14 minutes if the calendar application 607 were deactivated.

In one embodiment, visual indicators (e.g., icons or text) associated with the applications bar 601 can be tinted based on a predetermined color coding to present energy consumption information to a user. For example, an application 107 or action that uses more energy can be tinted red while an application 107 or action that uses less energy can be tinted green. Additionally, the home screen of the UE 101 can have a background wallpaper that changes color to reflect the energy usage of the UE 101. For example, the background wallpaper can be tinted green when a small amount of energy is being consumed, yellow when a moderate amount of energy is being consumed, and red when a great amount of energy is being consumed. Moreover, the user may change performance and power settings of an action or application via performing a gesture (e.g., a right mouse click) on a visual indicator or by performing another gesture (e.g., rotating the UE 101 or using other haptic technology) associated with the application 107. In one scenario, the visual indicator could be a messaging application 611 and the parameters could be the frequency of checking messages. A single gesture, such as a sliding gesture on a sliding interface 613 can be used to change frequency parameters (e.g., from a 5 second synchronization to a 10 minute synchronization). Moreover, additional input mechanisms can be utilized to change energy consumption settings, such as a voice command using a microphone of the UE 101 or any other setting input change setting made available by the application 107.

FIG. 6B is a diagram of a user interface 620 utilized in the processes of FIG. 3, according to one embodiment. The user interface 620 displays energy consumption information to a user indicating the power consumption of bookmarks. Bookmarks 621, 623, 625, 627 can be color coded (not shown) to display the energy consumption associated with the activation of a bookmark action. For example, a video link 621 can have a red tint to represent that the video link 621 consumes a large amount of energy, while an audio link 623 or flash link 625 is associated with a yellow tint representing that these links consume a moderate amount of energy and a text link 627 can be associated with a green color representing that the text link 627 uses a small amount of energy. Additionally, the links can be associated with battery life estimate values. For example, clicking on the video link 621 can reduce the battery life of the UE 101 to 1 hour and 5 minutes. Additionally, the processes allow for other file and link management user interfaces, such as a file manager, or an active web page to be used instead of a bookmark list.

FIG. 6C is a diagram of a user interface 640 utilized in the processes of FIGS. 3 and 5, according to various embodiments. The user interface 640 displays links on a web browser associated with a UE 101. The links can be shaded or tinted using different colors as described in FIGS. 6A and 6B representing the power consumption of the UE 101 if the link was activated. Links 641, 643, 645, 647, 649, and 651 may be associated with a green tinting because the links lead to a text-based web page. Moreover, link 653 may be associated with a yellow tinting because the link leads to an audio recording that uses a moderate amount of energy consumption. Further, link 655 may be tinted a red to represent a large amount of energy consumption because the link leads to a video, which can consume a great deal of energy.

FIG. 6D is a diagram of a user interface 660 utilized in the processes of FIG. 4, according to one embodiment. The user interface 660 displays an interface to online store 115. The online store 115 can offer for download a plurality of applications 661, 663, 665, 667, 669, 671. The applications 661, 663, 665, 667, 669, 671 can be presented in a manner that displays energy consumption information (e.g., an energy consumption battery life if the application was running on a full battery charge). For example, a messaging application 665 can run for 12 hours and 32 minutes on the particular type of UE 101 that the user is currently using based on a full battery charge. The UE 101 type can be provided by the user to the online store 115 to allow the online store 115 to provide UE 101 specific information. Alternatively or additionally, the applications 661, 663, 665, 667, 669, 671 can be tinted a color based on the energy consumption of the particular application.

The processes described herein for providing measurement and visualization of the energy consumption of applications and actions may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

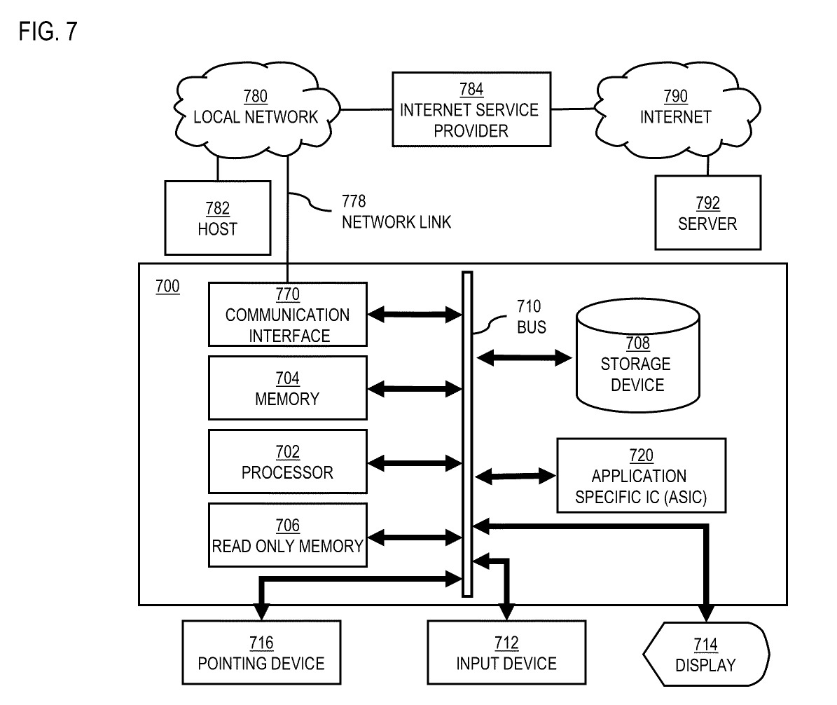

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to measure and visualize energy consumption of applications and actions as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of measuring and visualizing energy consumption of applications and actions.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to measuring and visualizing energy consumption of applications and actions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for measuring and visualizing energy consumption of applications and actions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for measuring and visualizing energy consumption of applications and actions, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing energy consumption information to the UE 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to measure and visualize energy consumption of applications and actions as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of measuring and visualizing energy consumption of applications and actions.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to measure and visualize energy consumption of applications and actions. The memory 805 also stores the data associated with or generated by the execution of the inventive steps.

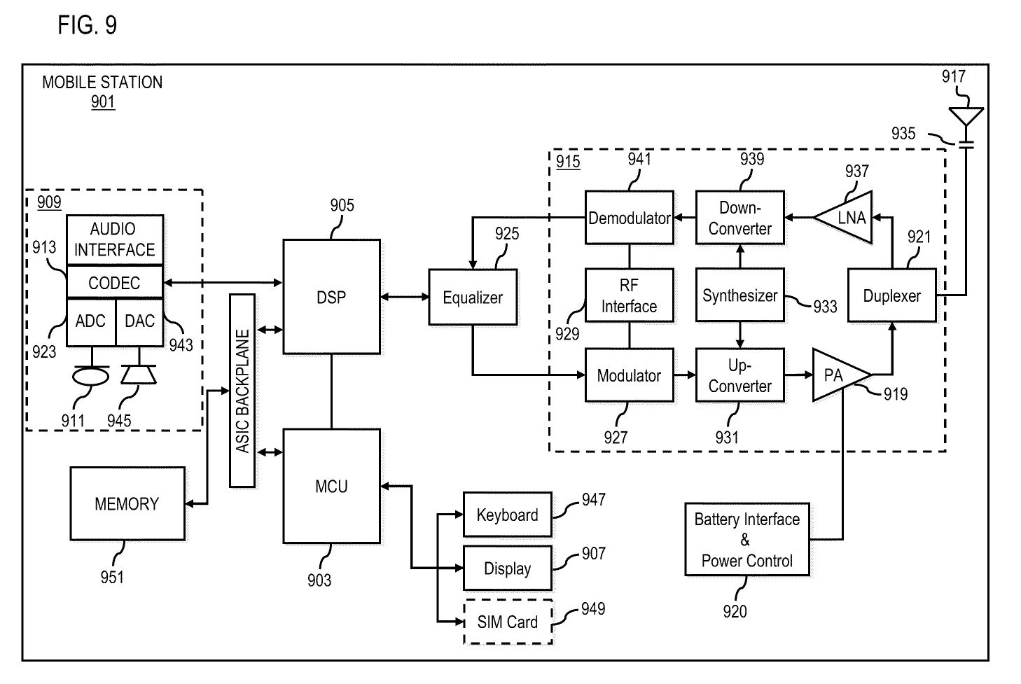

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of measuring and visualizing energy consumption of applications and actions. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of measuring and visualizing energy consumption of applications and actions. The display unit 907 includes display circuitry configured to display at least a portion of a user interface of the mobile terminal (e.g., mobile telephone). Additionally, the display unit 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to measure and visualize energy consumption of applications and actions. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining energy consumption information of an action or application configured to be executed on a user equipment; and
causing, at least in part, presentation, via a graphical user interface of the user equipment, of the energy consumption information along with a visual indicator representing the action or the application.

2. A method of claim 1, wherein the energy consumption information includes a ranking, wherein the method further comprises:
modifying the visual indicator based on the ranking.

3. A method of claim 1, further comprising:
determining advisory information based on the energy consumption information; and
causing, at least in part, presentation of the advisory information via either the graphical user interface of the user equipment, an auditory output of the user equipment, a haptic output of the user equipment, or a combination thereof.

4. A method of claim 1, wherein the action is processing an internet link, the method further comprising:
estimating a download time power consumption of content associated with the internet link;
estimating a scrolling need power consumption of the content; and
estimating a viewing time power consumption of the content,
wherein the energy consumption information is determined, at least in part, by the download time power consumption, the scrolling need power consumption, and the viewing time power consumption.

5. A method of claim 1, wherein the energy consumption information is based at least in part on a use of the action or the application on the user equipment, an efficiency setting of the action or the application, a community average energy consumption value associated with the action or the application, or a combination thereof.

6. An apparatus comprising:
at least one processor; and
at least one memory including computer program code,
the at least one memory and the computer program code configured to, with the at least one processor, cause the apparatus to perform at least the following,
determine energy consumption information of an action or application configured to be executed on a user equipment; and
initiate presentation, via a graphical user interface of the user equipment, of the energy consumption information along with a visual indicator representing the action or the application.

7. An apparatus of claim 6, wherein the energy consumption information includes a ranking, and wherein the apparatus is further caused to:
modify the visual indicator based on the ranking.

8. An apparatus of claim 6, wherein the apparatus is further caused to:
determine advisory information based on the energy consumption information; and
cause, at least in part, presentation of the advisory information via either the graphical user interface of the user equipment, an auditory output of the user equipment, a haptic output of the user equipment, or a combination thereof.

9. An apparatus of claim 6, wherein the action is processing an internet link, and wherein the apparatus is further caused to:
estimate a download time power consumption of content associated with the internet link;
estimate a scrolling need power consumption of the content; and
estimate a viewing time power consumption of the content,
wherein the energy consumption information is determined, at least in part, by the download time power consumption, the scrolling need power consumption, and the viewing time power consumption.

10. An apparatus of claim 6, wherein the energy consumption information is based, at least in part, on a use of the action or the application on the user equipment, an efficiency setting of the action or the application, a community average energy consumption value associated with the action or the application, or a combination thereof.

11. A method comprising:
determining energy consumption information for a plurality of applications configured to be executed on a user equipment; and
causing, at least in part, to associate the energy consumption information with the respective applications as part of an online service.

12. A method of claim 11, wherein the online service is an online store, the method further comprising:
causing, at least in part, presentation of the energy consumption information along with visual indicators representing the respective applications.

13. A method of claim 12, wherein the energy consumption information is associated with a color for each respective application and the visual indicator is tinted with the color.

14. A method of claim 11, further comprising:
determining advisory information based on the energy consumption information; and
causing, at least in part, presentation of the advisory information.

15. A method of claim 11, further comprising:
causing, at least in part, to associate the energy consumption information with a type of user equipment.

16. An apparatus comprising:
at least one processor; and
at least one memory including computer program code,
the at least one memory and the computer program code configured to, with the at least one processor, cause the apparatus to perform at least the following,
determine energy consumption information for a plurality of applications configured to be executed on a user equipment; and
associate the energy consumption information with the respective applications as part of an online service.

17. An apparatus of claim 16, wherein the online service is an online store, and the apparatus is further caused to:
cause, at least in part, presentation of the energy consumption information along with visual indicators representing the respective applications.

18. An apparatus of claim 17, wherein the energy consumption information is associated with a color for each respective application and the respective visual indicator is tinted with the color.

19. An apparatus of claim 16, wherein the apparatus is further caused to:
determine advisory information based on the energy consumption information; and
cause, at least in part, presentation of the advisory information.

20. An apparatus of claim 16, wherein the apparatus is further caused to:
cause, at least in part, to associate the energy consumption information with a type of user equipment.
